(19) United States
(12) Patent Application Publication
(10) Pub. No.: US 2020/0248735 A1
(43) Pub. Date: Aug. 6, 2020

(54) SHAPED COMPONENT, METHOD FOR CONNECTING AT LEAST ONE METAL-SHEET COMPONENT TO A SHAPED COMPONENT, AND SYSTEM OF A METAL-SHEET CONSTRUCTION

(71) Applicant: Pflitsch GmbH & Co. KG, Hueckeswagen Nordrhein Westfalen (DE)

(72) Inventor: Roland SCHMITZ, Wipperfuerth (DE)

(73) Assignee: Pflitsch GmbH & Co. KG, Hueckeswagen Nordrhein Westfalen (DE)

(21) Appl. No.: 16/856,821

(22) Filed: Apr. 23, 2020

Related U.S. Application Data
(63) Continuation of application No. PCT/EP2018/078887, filed on Oct. 22, 2018.

(30) Foreign Application Priority Data
Oct. 23, 2017 (DE) 10 2017 124 708.4

(51) Int. Cl. F16B 33/00; F16B 5/06; F16B 17/00; B21D 39/03

(52) U.S. Cl. CPC F16B 33/002; F16B 5/0635; B21D 39/032; F16B 5/0642; F16B 17/008

(57) ABSTRACT

A shaped component includes a main metal sheet and at least one torsion tab. The torsion tab has a torsion region and a tab head. An extension of the torsion region perpendicular to a center longitudinal axis of the torsion tab is less than an extension of the tab head perpendicular to the center longitudinal axis of the torsion tab such that the tab head provides a clamping region for clamping a sheet metal component such as a cable guide component to the main metal sheet. Also, the shaped component can include at least two torsions tabs such that at least two sheet metal components can be clamped to the shaped component.

### CROSS-REFERENCE TO RELATED APPLICATIONS

This application is a continuation of International Application No. PCT/EP2018/078887, filed on Oct. 22, 2018, which claims priority to and the benefit of DE 10 2017 124 708.4, filed on Oct. 23, 2017. The disclosures of the above applications are incorporated herein by reference.

### FIELD

The present disclosure relates to a shaped component, to a method for connecting of at least one sheet metal component to a shaped component, and to a system of a sheet metal construction at least comprising a first sheet metal component and at least one shaped component.

### BACKGROUND

The statements in this section merely provide background information related to the present disclosure and may not constitute prior art.

Shaped components intended for connecting of sheet metal components, in particular of cable ducts, are generally known from the prior art. Document DE 20 106 642 U1, for example, describes an apparatus for connecting of trough-shaped shaped components which are designed as having a U-shaped cross section and whose leg near the base of the U-shape features inward-extending ribbing progressing in the longitudinal direction of the shaped component. The connectors herein are designed as flat plates which feature a solid longitudinal ribbing in the vicinity of a longitudinal border. These connectors are connected by screws to two shaped components joined end to end.

Document WO 00/04295 A1 describes a connection for sheet metal parts positioned perpendicular to each other. By twisting a tab protruding past one edge of the sheet metal part, the sheet featuring the tab is tensioned with a sheet metal part arranged perpendicular thereto and featuring a corresponding opening.

The disadvantage of the connections of sheet metal parts known from the prior art is that a screw connection requires a significant effort for its installation. Furthermore, due to the additional parts required in this regard, the screw connections are cost-intensive, especially in regard to larger projects.

### SUMMARY

This section provides a general summary of the disclosure and is not a comprehensive disclosure of its full scope or all of its features.

In one form of the present disclosure a shaped component includes a main metal sheet and at least one torsion tab. The torsion tab features or includes a torsion region and a tab head, and an extension of the torsion region perpendicular to a center longitudinal axis of the torsion tab is smaller or less than an extension of the tab head perpendicular to the center longitudinal axis of the torsion tab. Also, the tab head comprises a clamping region and the torsion tab protrudes from a main metal sheet plane.

In another form of the present disclosure, a method for connecting at least one first sheet metal part with a shaped component includes guiding at least one first torsion tab of the shaped component through a first recess of a first sheet metal part, twisting the first torsion tab by about 10° to about 170° about its central longitudinal axis, and a tab head of the torsion tab cooperates with the first sheet metal part such that the tab head tensions the first sheet metal part with a main metal sheet of the shaped component. As used herein, the term “tensions” refers to holding or clamping together at least two parts together.

In still another form of the present disclosure, a system of a sheet construction includes a first sheet metal part and at least one shaped component with at least one torsion tab of the at least one shaped component extending through at least one recess of the first sheet metal part. The at least one torsion tab is twisted by about 10° to about 170° about its center longitudinal axis such that a tab head of the at least one torsion tab cooperates with the first sheet metal part such that a main metal sheet of the shaped component is tensioned or held into contact with the first sheet metal part.

Now whereas the term “about” is used in conjunction with the present disclosure when referring to values or value ranges, then this is intended to mean a tolerance range which the skilled person in this field will deem as common and usual, in particular a tolerance range of ±20%, preferably ±10%, more preferably ±5% is meant.

A shaped component comprising a main metal sheet and at least one torsion tab is provided, wherein the at least one torsion tab has a torsion region and a tab head. An extension of the torsion region perpendicular to a center longitudinal axis of the torsion tab is smaller or less than an extension of the tab head perpendicular to the center longitudinal axis of the torsion tab, and the tab head comprises a clamping region.

In some variations of the present disclosure, the shaped component is made from sheet metal. Non limiting examples of materials for making the shaped component include steel, stainless steel, aluminum, tin plate, copper and brass, among others. In other variations, the shaped component comprises a synthetic material, in particular a thermoplastic material and/or an intrinsically conducting plastic. In at least one variation the shaped component is at least partially coated with a plastic material. In some variations the shaped component is designed at least partly of plastic material. It should be understood that the term “sheet material” as used herein refers to any and all large-area materials being essentially flat, especially independently of the material of the large-area sheet.

In an additional form of the present disclosure the shaped component features at least one electric circuit path. In particular, the at least one electric circuit path is arranged such that at least it can be used to establish an electrically conducting connection with at least one sheet metal component. In an additional configuration the present disclosure provides that the shaped component, and preferably a material of the shaped component, is inherently electrically conducting. In an additional configuration the present disclosure provides that at least one surface is designed or configured as being at least partly electrically conducting. By means of an electrical conductivity of the shaped component, an electrically conducting connection can be established between at least one sheet metal component and the shaped component or between two shaped components. In particular, a compensation of potential can be created between sheet metal component and shaped component by an electrical connection. In an additional configuration the present disclosure provides that the shaped component features electrical properties corresponding to DIN EN 61537:2007 Standard, for example in connection with at least one additional shaped component and/or at least one sheet metal component. A compensation of potential and/or at least a connection to ground can be established by the shaped component. In an additional form the present disclosure provides that via the torsion tabs, a compensation of potential can be established, for example with the ground or between at least one sheet metal component and the shaped component or between two shaped components.

For example, an electrical conductance is provided between two metal-sheet components and the shaped component, or between two shaped components, which exhibits an impedance of less than or equal to 50 ma across a connection point, wherein an alternating current of 25 A±1 A is applied at a frequency of 50 Hz to 60 Hz from a voltage source, with a bias voltage of not more than 12 V, across the connection point of the two sheet metal components and the shaped component or between two shaped components, wherein a voltage drop is measured between two points which are located 50 mm distant from each side of the connection point. The connection point is in particular the overlap region of the shaped component with the sheet metal components or the two shaped components.

In some variations, the shaped component comprises a main metal sheet and the at least two torsion tabs, wherein the torsion tabs are formed from the main metal sheet, for example punched out, milled or sawn from the main metal sheet. In one configuration the torsion tabs are connected to the main metal sheet as a single piece. Within the meaning of the present disclosure, the term “main metal sheet” means a component or a section of a component which acts as the base for an additional component, but also a component or a section of a component from which an additional component is extracted and in particular is materially connected thereto. In one configuration the main metal sheet is a wall, an extension, or a bottom of a shaped component.

Within the meaning of the present disclosure, a “single piece” means that the parts are molded and/or produced essentially from one workpiece, i.e., two parts are essentially materially connected and/or formed from a single piece of material.

In one configuration the present disclosure provides that the at least one torsion tab is materially connected to the main metal sheet, that is, it is designed as a single piece. In particular, the at least one torsion tab is detached from, preferably punched out from a base material of the main metal sheet. It some variations the torsion tab is at least partly and/or at least simply bent.

The term “essentially” denotes a tolerance range which relates to financial and technical considerations for the skilled person, such that the corresponding feature can still be recognized and/or implemented as such.

In one configuration the present disclosure provides that the at least one torsion tab has a geometry which allows a twisting of the torsion tab, for example a twisting about a center longitudinal axis thereof. In another configuration the torsion region of the torsion tab is connected to the main metal sheet. In at least one variation an extension of the torsion region perpendicular to the center longitudinal axis amounts or is equal to about one-half, for example about ¼ or about ⅛ of an extension of the tab head perpendicular to the center longitudinal axis. In some variations, the present disclosure provides that the extensions perpendicular to the center longitudinal axis are also perpendicular to the material thickness of the torsion tab.

In some variations of the present disclosure the shaped component is manufactured from one part, or rather from one workpiece. The workpiece can be a sheet, for example a metallic sheet. In an additional configuration the present disclosure provides that the workpiece is stamped, for example at least in part to form the shaped component. In at least one variation, an outer contour of the shaped component is formed essentially by stamping. In another form, the shaped component has embossing. In one configuration the present disclosure provides that the torsion tab is punched out. In one configuration the torsion tab is materially locked to the main metal sheet. In particular, the torsion tab with the torsion region is disposed on the main metal sheet. In an additional form, the stamping of the torsion tab takes place such that the torsion tab with the torsion region is disposed on the main metal sheet.

In one configuration the present disclosure provides that the torsion tab is bent outward or is canted away from the plane of the main metal sheet.

In an additional configuration the present disclosure provides that the center longitudinal axis of the torsion tab relative to a plane of the main metal sheet has an angle of about 30° up to about 150°, for example about 80° up to about 100°, for example about 90°. According to the present disclosure the torsion tabs extend from the plane of the main metal sheet. The advantage of the torsion tab being bent outward from the plane of the main metal sheet is that this tab can be easily inserted into a corresponding recess, without the torsion tab having to be bent into an appropriate position, for example with the assistance of a tool.

Within the meaning of the present disclosure, the “plane of the main metal sheet” is understood to mean a plane which is parallel to the essentially planar main metal sheet or to an essentially planar main metal sheet section. The plane of the main metal sheet is an essentially planar surface, or an essentially planar surface section of the main metal sheet.

In an additional form the present disclosure provides that the shaped component features two, for example four torsion tabs. In one configuration the two torsion tabs, e.g., their tab heads in an untwisted state, are arranged essentially parallel to each other. In an additional configuration the present disclosure provides that the two torsion tabs, e.g., their tab heads in the untwisted state, are arranged essentially not parallel to each other. In such a configuration the present disclosure provides that at least two torsion tabs, e.g., their tab heads in the untwisted state, can be arranged at an angle to each other of about 30° up to about 60°, for example about 45°. A non-parallel arrangement of the torsion tabs to each other has the advantage that a defined positioning of the shaped component is possible, for example, on a sheet metal component, especially when no positioners is provided.

In an additional configuration the present disclosure provides that the torsion tabs extend from the main metal sheet plane from the same side or from opposing sides of the main metal sheet. This can be used for connecting of components arranged in parallel. For example, in one configuration the present disclosure provides that on a first side of the main metal sheet a first metal-sheet component is mounted, and on a second side of the main metal sheet a second sheet metal component is mounted, so that the sheet metal components are attached to each other at a spacing of the material thickness of the main metal sheet in the region of the main metal sheet.

In another configuration, the shaped component is used to connect two sheet metal components together edge to edge. In this regard a first torsion tab is inserted into a recess of a first sheet metal component and a second torsion tab is inserted into an additional recess of a second sheet metal component. The torsion tabs are subsequently twisted, that is, they are twisted wherein a torsion is applied essentially in the torsion region and the twisting of the torsion tabs produces a positive-locking connection. In an additional configuration the present disclosure provides that the clamping region of the tab head upon twisting thereof acts on the sheet metal component such that the shaped component and/or the main metal sheet of the shaped component is clamped to the sheet metal components.

In another form of the present disclosure, clamping of the shaped component and the main metal sheet provides a secure electrically conducting connection. For example clamping provides a compensation of potential between the shaped component and the sheet metal component. In an additional form the present disclosure provides that an electrically conducting connection of the main metal sheet and/or of the torsion tab to the sheet metal component is provided which provides a reliable contact, especially due to the clamping.

The tab head features a clamping region. In particular, the tab head is divided into a clamping region and a grip area. In one configuration the tab head features a grip area which is designed such that it can be easily grasped with a tool opening of an additional, or another—perhaps also alternatively shaped—component, with an electrician's tongs and/or pliers.

In an additional configuration the tab head comprises essentially only one clamping region. The clamping region in one configuration is designed such that cheeks of the clamping region point essentially toward the main metal sheet, essentially or partially in an install situation of the shaped component indicated according to the present disclosure. In particular, in one configuration the present disclosure provides that the clamping region in the direction of the center longitudinal axis away from the torsion region features an increasingly greater extension perpendicular to a center longitudinal axis. In an additional configuration the present disclosure provides that at least one cheek, preferably at least in one section of the clamping region, has an angle to the plane of the main metal sheet of about 5° up to about 80°, for example about 7° up to about 60°, about 10° up to about 35°, or about 12° up to about 28°. In an additional form the present disclosure provides that at least one cheek, for example at least in one section of the clamping region, has an angle to the center longitudinal axis of the torsion tab from about 20° up to about 85°, for example about 30° up to about 83°, or about 62° up to about 78°, wherein the apex of the angle is allocated to the torsion region and the angle opens from the tab head in the direction of the main metal sheet. The torsion can be applied in any particular direction.

In some configurations, the torsion tab has a torsion region and a tab head. The tab head features an extension which is significantly broader or greater than an extension of the torsion region. In one form the tab head additionally also features a clamping region which broadens, for example consistently or continuously, proceeding from the torsion region in the direction of the center longitudinal axis and away from the torsion region. In at least one configuration, the cheeks of the clamping region are designed as being arranged straight in a longitudinal section in a top view. In one form, the cheeks feature an angle to the main metal sheet plane which amounts to about 10° up to about 30°. In another configuration the torsion region comprises a foot region which is in particular an angled and/or a curved section, wherein the foot region is materially connected or is connected as a single piece to the main metal sheet. Also, the foot region comprises a section which is arranged in the main metal sheet plane. In some configurations the present disclosure provides that a spring force, or a spring constant, of the torsion region, especially before and/or after a twisting thereof, is adjustable by a length of the foot region which is located in the main metal sheet plane. For example, slits in the main metal sheet are provided for the torsion region, e.g., for the foot region. In an additional configuration the foot region in the direction of the material-locking connection with the main metal sheet has a trapezoidal design. In particular, one base of the trapezoidal shape of the material-locking connection is assigned to the main metal sheet. In at least one configuration, the foot region, for example the portion of the foot region which is arranged in the main metal sheet plane, has a rectangular design.

In some variations the torsion region is that section of the torsion tab which is at least partly deformed by the twisting of the torsion tab about the center longitudinal axis. Depending on the torsion on the torsion tab, a deformation can also occur in the tab head, for example in the clamping region and/or in the region of the clamping region adjoining the torsion region. In one form the clamping region is designed such that after the torsion (e.g., twisting) of the torsion tab, the torsion tab has a distance (e.g., a maximum distance), at least in one partial region, which corresponds to an expected sheet thickness ‘b’ of the sheet metal component which is connectable to the shaped component. Accordingly, and due to the cheek of the clamping region arranged at an angle to the main metal sheet plane, different sheet metal components with different sheet thicknesses b can be connected to the shaped component.

Within the meaning of the present disclosure, a “cheek” of the clamping region is a surface extending over the material thickness of the tab head, for example extending perpendicular to an area extension of the torsion tab. In some variations the cheek extends between the torsion region and a region of the tab head which features essentially no enlarged extension in the direction of the longitudinal axis of the torsion tab away from the torsion region. In particular, the cheek of the clamping region can be the region of the tab head which acts (e.g., applies force) on a sheet metal component when the torsion tab is twisted. In one configuration the cheeks of the clamping region are designed such that they can apply a force onto a sheet metal component. In one additional configuration the present disclosure provides that the clamping region features cheeks which extend linearly in a longitudinal section. In one additional configuration the present disclosure provides that the cheeks are designed or configured as bent in a longitudinal section. In at least one variation, the clamping region features a material thickness that corresponds to the material thickness of the main metal sheet.

In at least one configuration the present disclosure provides that the tab head can be twisted. In some configurations the present disclosure provides that the torsion region can be twisted by twisting of the tab head. In at least one configuration the present disclosure provides that the clamping region can be twisted, at least in part, by twisting of the tab head.

Within the meaning of the present disclosure, a “torsion” means a twisting of a body or of a section of a body, which acts due to the effect of torque on this body or section of a body.

In some configurations the present disclosure provides that the torsion region and the tab head have essentially the same material thickness. In at least one configuration the present disclosure provides that the torsion region has a length in the direction of the center longitudinal axis of about 2 mm to about 15 mm, for example about 2 mm up to about 10 mm, about 2 mm up to about 6 mm, about 5 mm, among others. In some configurations the present disclosure provides that the torsion region has a length in the direction of the center longitudinal axis from about 0.5 times up to about 2 times the material thickness of the main metal sheet, for example about 0.5 times up to about 1.5 times the material thickness of the main metal sheet, about 0.5 times up to about one times the material thickness of the main metal sheet, about 0.5 times up to about three-quarters of the material thickness of the main metal sheet, about one-half the material thickness of the main metal sheet, among others.

Within the meaning of the present disclosure, the “material thickness” is understood to mean the thickness of the shaped component or of the sheet metal component at a particular location. In some variations the material thickness is essentially the same at each location of the shaped component. In at least one configuration the present disclosure provides that the material thickness at twisted and/or bent locations of the shaped component differs from the material thickness of a not bent or untwisted main metal sheet.

In one form the present disclosure provides that the torsion region is designed such that when under torsion it is shortened in the direction of the center longitudinal axis. In particular, the present disclosure provides that during an assembly of a sheet metal component with a greater material thickness, a torsion occurs about a smaller angle than for a sheet metal component with a smaller material thickness. Accordingly, the torsion tab in a sheet metal component with a greater material thickness is twisted less severely than for a sheet metal component with lesser material thickness in order to clamp the sheet metal component with the main metal sheet with an essentially equal force.

In some configurations the present disclosure provides that the torsion tab can be twisted with a torque of about 0.3 Nm up to about 5 Nm, for example about 0.5 Nm up to about 3 Nm, about 1.5 Nm up to about 2 Nm, among others, at about 45°. In some variations the tab head of the torsion tab can be twisted by about 45° with a torque of about 0.3 Nm up to about 5 Nm, for example about 0.5 Nm up to about 3 Nm, about 1.5 Nm up to about 2 Nm, among others.

In at least one configuration the present disclosure provides that the main metal sheet features at least one screw hole. The at least one screw hole in one variation is a solid opening having no threads. In another variation the at least one screw hole does have threads. In some configurations the present disclosure provides that the screw hole is assigned to one torsion tab. In particular, the screw hole is arranged in the vicinity of the torsion tab. In an additional configuration the present disclosure provides that the screw hole, in particular a section or point of the perimeter of the screw hole located nearest to the torsion tab, has a distance from the torsion tab, in particular from the torsion region, that is less than the radius of the screw hole. In some variations the present disclosure provides that a distance from a midpoint of the screw hole to the torsion tab is less than 1.5 times the diameter of the screw hole. Also, the screw hole is assigned to the torsion region of the torsion tab. In at least one variation the present disclosure provides that the distance of a midpoint of the screw hole to the untwisted torsion tab amounts or is equal to about one-half of a hex-head wrench width which correlates with a nominal diameter of the screw hole.

Within the meaning of the present disclosure the wrench width means the distance of two essentially parallel surfaces, in particular of a tool for transmission of torque, by positive locking. In at least one variation the wrench width is the nominal width of an Allen wrench for hex-head screws or nuts. The ratio of the rated diameter of the screw hole to the wrench width is defined in particular in the standard DIN EN 24014 in connection with the standard DIN EN 24017 dated February 1992. For example, at a rated diameter of the screw hole of 3 mm, a rated wrench width of 5.5 mm is provided; at a rated diameter of the screw hole of 5 mm, a rated wrench width of 8 mm is provided; at a rated diameter of the screw hole of 6 mm a rated wrench width of 10 mm is provided; and at a rated diameter of the screw hole of 8 mm, a wrench width of 13 mm is provided. In particular, the torsion tab is disposed with respect to the screw hole such that it acts as a torsion guard for a hex head screw or a nut.

In an additional configuration the present disclosure provides that an opening is formed by bending of the at least one torsion tab outward from the main metal sheet plane. In one form the present disclosure provides that the opening is designed as a screw hole. In particular, the opening is essentially round. In one configuration the opening features approximately a diameter that corresponds to a nominal diameter of a screw hole. In an additional form the present disclosure provides that the distance of a midpoint of the opening to the untwisted torsion tab amounts to about one-half of a hex-head wrench width which correlates with a nominal diameter of the opening. Furthermore, in one configuration the statements provided above regarding the at least one screw hole can be applied analogously to the opening.

In some configurations the present disclosure provides that the shaped component comprises at least one positioner. In at least one configuration the positioner is an elevation from the main metal sheet. In some configurations, the positioner extends from the main metal sheet. The present disclosure provides that the positioner extends beyond the main metal sheet by about 5% up to about 150%, for example about 20% up to about 120%, and about 80% up to about 100%, among others, of the material thickness of the main metal sheet perpendicular to the main metal sheet plane. In some configurations the present disclosure provides that the positioner is a part detached from, for example is punched out from the main metal sheet. In at least one configuration the positioning means is connected to the main metal sheet, for example by material-locking. In some configurations the positioner is connected to the main metal sheet as a single piece. In particular, the positioner is detached from the main metal sheet and is twice bent around (double bending), wherein an essentially planar surface is arranged essentially parallel to the main metal sheet plane. In at least one configuration the present disclosure provides that an essentially planar surface adjoins the doubled edging. In some configurations the at least one positioner is detached from the main metal sheet and is connected to the main metal sheet by a single bend.

In some configurations the present disclosure provides that the positioner features an extension that is designed as parallel to the main metal sheet plane. For example, the positioner features an extension from the main metal sheet progressing essentially parallel to the main metal sheet plane, in particular for a double bending. In other configurations the positioning means features an essentially angled extension progressing from the main metal sheet to the main metal sheet plane, in particular for a single bending.

In one configuration the present disclosure provides that the positioner features a surface which extends in the direction of the extension, wherein the surface of the positioner is parallel to a surface of the main metal sheet. In some configurations the present disclosure provides that the main metal sheet features a material thickness d which is essentially identical to the material thickness p of the positioner. Furthermore, the torsion tab in one form features a material thickness t which is essentially identical to the material thickness d of the main metal sheet.

In one form of the present disclosure, at least two, for example four, positioners are provided. In at least one configuration the present disclosure provides that the at least two positioning means are arranged as mirror-symmetrical to each other. Preferably the at least two positioners are arranged with respect to each other such that the angled sides, or rather the sides that are material-locked with the main metal sheet, point to of face each other. In some configurations the present disclosure provides that the at least two positioners are arranged with respect to each other such that the sides positioned opposite the angled sides point to or face each other.

In one variant of the shaped component the torsion tabs and also the positioners are located in the main metal sheet plane. In particular, the torsion tabs, the positioners, the screw holes and/or a material attenuation are detached from, and in particular are punched out from the main metal sheet in one work step. For example, a bending and/or edging of the torsion tabs and of positioners does not occur. A design of this kind reduces in particular the warehousing costs and shipping costs, since a molded part (e.g., a shaped component) punched out in this manner requires significantly less storage space. The positioners and/or the torsion tabs can each be bent out and mounted as needed at the installation site. That is, in some configurations a plurality of main metal sheets are punched such that the torsion tabs, the positioners, the screw holes and/or a material attenuation are formed from each main metal sheet, but bending and/or edging of the torsion tabs and of positioners does not occur. The plurality of punched main metal sheets are stored and/or shipped in this configuration and upon arriving at an installation site bending and/or edging of torsion tabs and positioners occurs as and when needed.

In some configurations the present disclosure provides that the main metal sheet between at least two torsion tabs comprises a material attenuation. In some variations the material attenuation is designed as a line, for example as a straight line. In at least one configuration the material attenuation features a plurality of recesses in the main metal sheet, which can be arranged in a straight line. In at least one configuration the present disclosure provides that the material attenuation is a single- or multiple-rolled and/or embossed region. For example, the material attenuation is arranged on an axis of symmetry of the main metal sheet. Also, bending of the main metal sheet along the material attenuation with a hand tool for example, or an edging of the main metal sheet along the material attenuation by use of a hand tool, for instance, is simplified. For example, if the shaped component is designed as a connector, then it can function as a corner connector in that the main metal sheet is edged preferably along the material attenuation. In some configurations the material attenuation is designed as a ribbing extending across the entire main metal sheet. In at least one configuration the present disclosure provides that the material attenuation is provided as a line-up of at least two, for example at least three, or at least four recesses extending all the way through the main metal sheet. In one form the recesses are rectangular, and in another configuration the recesses are round. In some configurations the present disclosure provides that the material attenuation features at least one, for example at least two, at least three, or at least four recesses, which are designed as not extending all the way through the main metal sheet. In at least one configuration the present disclosure provides that the material attenuation comprises a recess extending from a first edge of the main metal sheet to an opposing edge of the main metal sheet and which does not go all the way through. In some variations the material attenuation comprises a notch. In some configurations the present disclosure provides that the recess features a tapered cross section in the direction of the material thickness of the main metal sheet. For example, the cross section of the recess can be wedge-shaped. In at least one configuration the present disclosure provides that the material attenuation forms a deformation line. Along the deformation line a bending can be executed with a smaller torque than bending along a line across the main metal sheet that does not exhibit any material attenuation. Also, a deformation or bending of the main metal sheet can be implemented along the deformation line, for example, by using pliers to apply a torque on opposing sides of the material attenuation so that the main metal sheet will bend.

In one form of the present disclosure the shaped component is designed as a connecting element. In particular, the connecting element features a main metal sheet. In some configurations the main metal sheet comprises a surface that is arranged in a main metal sheet plane and two, four, or preferably six torsion tabs protrude from the main metal sheet. In at least one configuration positioners and screw holes are each associated with the torsion tabs. For example, one positioner and one screw hole each are allocated to each torsion tab. In at least one configuration the present disclosure provides that only one, only two, or only three torsion tabs are allocated to one positioner. In the alternative, the present disclosure provides that only every second or every third torsion tab is allocated to one positioner. In some configurations the present disclosure provides that one or a plurality of positioners are arranged on the main metal sheet, independently of one or of a plurality of torsion tabs. In at least one configuration, the torsion tabs extend essentially perpendicular to the main metal sheet plane and in the same direction from the surface of the main metal sheet. The positioners are elevated from the main metal sheet plane. Both the torsion tabs and also the positioners in one configuration are detached from or are punched out from the material of the main metal sheet. By bending the torsion tabs out from the main metal sheet plane, openings are produced which are allocated to the torsion tabs. For example, the present disclosure provides that the main metal sheet features a number of rectangular material attenuations which are arranged in a line, in particular a straight line. The material attenuations in one form separate one, two, three, or more than three torsion tabs or pairs of torsion tabs. In some configurations, the material attenuations are structured such that a slight bending along the deformation line created by the material attenuations is easily provided, for example, with a hand tool. In at least one configuration the present disclosure provides that the main metal sheet features four torsion tabs, and one screw hole and one positioner and/or the opening are allocated to each torsion tab. In some configurations the torsion tabs, the positioners and/or the screw holes are allocated to one corner of the main metal sheet.

In at least one configuration the torsion tabs are arranged upon the base pate such that every two torsion tabs are arranged mirror-symmetrical to each other, and the deformation line formed by the material attenuation forms the axis of symmetry. In some configurations the present disclosure provides that the openings from which the torsion tabs are bent out, are each arranged in the same direction relative to the torsion tabs. Furthermore, in at least one configuration the positioners are each allocated to the openings. For example, the configuration of the positioners is such that every two positioners are arranged along an axis of symmetry reflected on the main metal sheet. For example, the positioners feature tilting directed toward each other on one side of the deformation line. The tilting pertains to the sections of the positioners which are bent around such that the positioners extend from the base plane out over the main metal sheet. In some configurations, the tilting is of the section of the positioner which is connected to the main metal sheet material.

In some configurations the shaped component comprises four torsion tabs which protrude from a main metal sheet plane. The four torsion tabs are allocated preferably to the corners of the main metal sheet. In at least one configuration, every two torsion tabs are arranged centrally roughly between an axis of symmetry of the main metal sheet and an outer edge of the main metal sheet.

In some configurations, the shaped component features four torsion tabs and one material attenuation, which features a plurality of recesses in the main metal sheet, are arranged in a straight line, and on an axis of symmetry of the main metal sheet.

In at least one configuration, the present disclosure provides that the shaped component features four torsion tabs and four positioners. For example, the four positioners can each be associated with the four torsion tabs. Furthermore, in some configurations, the present disclosure provides that two positioners are associated with each one outer edge. In at least one configuration, the present disclosure provides that at least two positioners are associated with one corner of the main metal sheet. For example, four torsion tabs, four positioners and one material attenuation are provided.

In some configurations, the present disclosure provides that the shaped component features four torsion tabs and four screw holes. For example, the four screw holes are each associated with the four torsion tabs. Furthermore, in at least one configuration, the present disclosure provides that two screw holes are associated with each one outer edge. In one form, the present disclosure provides that at least two screw holes are associated with one corner of the main metal sheet. For example, four torsion tabs, four screw holes and one material attenuation are provided.

In at least one configuration, the present disclosure provides that the shaped component features four torsion tabs and four screw holes and four positioners. For example, the four screw holes and the four positioners are each associated with the four torsion tabs. Furthermore, in some configurations, the present disclosure provides that two screw holes and two positioners are associated with each one outer edge. In at least one configuration, the present disclosure provides that two screw holes and two positioners are associated with one corner of the main metal sheet. For example, four torsion tabs, four positioners, four screw holes and one material attenuation are provided.

In another form of the present disclosure, a shaped component (also referred to herein as an “alternative shaped component”) comprising a main metal sheet featuring at least one tool opening for twisting of a torsion tab of a second shaped component is provided. The at least one tool opening is associated with one edge of the main metal sheet. In some configurations, the present disclosure provides that at least one corner of the main metal sheet is associated with at least one tool opening. In at least one configuration, the present disclosure provides that a material attenuation, for example in the form of a deformation line, formed with one or a plurality of recesses, is associated with at least one tool opening, and can be associated with one upper edge or lower edge of the main metal sheet. In some configurations the present disclosure provides that at least two, at least three, or at least four tool openings are arranged in the main metal sheet. In at least one configuration, the present disclosure provides that one tool opening is associated with all corners of the main metal sheet.

In some configurations the at least one tool opening is of rectangular structure, such that a torsion tab of a second, equally punched out shaped component, can be inserted through the tool opening. In at least one configuration the present disclosure provides that a longitudinal extension of the tool opening is provided at an angle from about 30° up to about 120°, about 30° up to about 60°, and about 45°, among others, to an outer edge of the main metal sheet or to a material attenuation designed as a deformation line.

In this form, the alternative shaped component additionally features those structures which are described above and below in connection with the at least one torsion tab. In particular the alternative shaped component comprises at least one torsion tab, wherein the torsion tab features a torsion region and a tab head, wherein an extension of the torsion region perpendicular to a center longitudinal axis of the torsion tab is smaller than an extension of the tab head perpendicular to a center longitudinal axis of the torsion tab, and wherein the tab head comprises a clamping region.

In some configurations the alternative shaped component comprises at least two, for example at least four torsion tabs. In at least one configuration the torsion tabs of the alternative shaped component are connected to the main metal sheet as a single piece. In some configurations the present disclosure provides that the center longitudinal axis of the torsion tab of the alternative shaped component has an angle of about 80° up to about 100° to a plane of the main metal sheet. The structures and positioning of the at least one torsion tab are designed in at least one configuration as corresponding to the shaped component described above.

In some configurations of the alternative shaped component, the present disclosure provides that the alternative shaped component features at least one screw hole. Preferably the at least one screw hole is associated with one torsion tab. In at least one configuration of the alternative shaped component, the present disclosure provides that the distance of a midpoint of the at least one screw hole to an untwisted torsion tab amounts to about one-half of a hex-head wrench width which correlates with a nominal diameter of the screw hole. The structures and positioning of the at least one screw hole is designed in some configurations as corresponding to the shaped component described above.

In at least one configuration the alternative shaped component comprises at least one positioner. Also, in some configurations the present disclosure provides that the at least positioner extends from the main metal sheet. The structures and positioning of the at least one positioner are designed in one form as corresponding to the shaped component described above.

In some configurations of the alternative shaped component, the present disclosure provides that the main metal sheet between at least two torsion tabs comprises at least one material attenuation and the material attenuation comprises a plurality of recesses in the main metal sheet. The structures and positioning of the material attenuation are designed in at least one configuration as corresponding to the shaped component described above.

In some configurations the alternative shaped component is configured as a connecting element for connecting of two sheet metal components. For example, the alternative shaped component can be used both for connecting of at least two sheet metal components, and also as a tool. In at least one configuration the present disclosure provides that the alternative shaped component is designed as corresponding to one configuration of the shaped component described above.

In some configurations, at least two sheet metal components, in particular cable guide components, are joined edge to edge for example, by at least one first shaped component. For example, torsion tabs, in particular two torsion tabs each, of the first shaped component are inserted through recesses, in particular through two recesses each, of the mutually connected sheet metal components. In at least one configuration an alternative shaped component can be bent off by about 90°, for example along the material attenuation, such that it can be used as a tool. In some configurations a torsion tab of an additional shaped component—arranged for example in the recess of the sheet metal component—can be grasped using the tool opening of the alternative shaped component. Furthermore, in at least one configuration the present disclosure provides that a torsion tab of an additional shaped component, arranged for example in the recess, can be twisted, by using and rotating of the alternative shaped component acting as tool.

In some configurations the present disclosure provides that a rotation of the alternative shaped component acting as tool, by an angle of about 30° up to about 50°, for example about 45°, causes a sufficient torsion of the torsion tab to connect and to clamp the shaped component to the sheet metal component in a positive-locking manner. For example, the tool opening can be installed in the main metal sheet such that a rotation of the alternative shaped component into a horizontal position causes a sufficient torsion of the torsion tab in order to clamp the shaped component to the sheet metal component. In at least one configuration, a horizontal position is a position of the alternative shaped component acting as tool, in which at least one edge of the sheet metal component, for example, of a cable guide component. As used herein, the term “horizontal” means essentially parallel to one primary axis of the metal-sheet component, in particular of a cable guide component. In some configurations, the edge of the main metal sheet encompasses four tool openings. The four tool openings are allocated to the corners of the main metal sheet. In at least one configuration, two tool openings are each allocated to one side of an axis of symmetry of the main metal sheet.

In some configurations, the alternative shaped component features four tool openings and one material attenuation, which features a plurality of recesses in the main metal sheet, which are arranged in a straight line, for example on an axis of symmetry of the main metal sheet. In at least one configuration, two tool openings are each allocated to one side of the material attenuation.

In some configurations the alternative shaped component comprises four torsion tabs which protrude from a main metal sheet plane. The four torsion tabs are allocated to the corners of the main metal sheet. In at least one configuration, every two torsion tabs are arranged centrally roughly between the deformation line and an outer edge of the main metal sheet. For example, four tool openings, four torsion tabs and one material attenuation are provided.

In some configurations, the present disclosure provides that the alternative shaped component features four torsion tabs and four positioners. In at least one configuration the four positioners are each associated with the four torsion tabs. Furthermore, in some configurations, the present disclosure provides that two positioners are associated with each one outer edge. In at least one configuration, the present disclosure provides that at least two positioners are associated with one corner of the main metal sheet. For example, four tool openings, four torsion tabs, four positioners and one material attenuation are provided.

In some configurations the present disclosure provides that the alternative shaped component features four torsion tabs and four screw holes. In at least one configuration, the four screw holes are each associated with the four torsion tabs. Furthermore, in some configurations, the present disclosure provides that each of two screw holes are associated with one outer edge. In at least one configuration, the present disclosure provides that at least two screw holes are associated with one corner of the main metal sheet. For example, four tool openings, four torsion tabs, four screw holes and one material attenuation are provided.

In some configurations, the present disclosure provides that the alternative shaped component features four torsion tabs and four screw holes and four positioners. In at least one configuration the four screw holes and the four positioners are each associated with the four torsion tabs. Furthermore, in one configuration, the present disclosure provides that two screw holes and two positioners are associated with each one outer edge. In some configurations, the present disclosure provides that two screw holes and two positioners are associated with one corner of the main metal sheet. For example, four tool openings, four torsion tabs, four positioners, four screw holes and one material attenuation are provided.

In still another form of the present disclosure, a method for connecting at least one first sheet metal component to a shaped component as described above is provided. At least one first torsion tab of the shaped component is guided through a first recess of the first sheet metal component, wherein the first torsion tab is twisted by about 10° up to about 170° around a center longitudinal axis of the torsion tab. A tab head of the torsion tab, for example a clamping region of the tab head, cooperates with the first sheet metal component such that the tab head, for example its clamping region, clamps the first sheet metal component with the main metal sheet of the shaped component. In some configurations the present disclosure provides that the recess is installed in the first sheet metal component before connecting of the shaped component to the sheet metal component. In at least one configuration the recess is installed in the sheet metal component which makes it possible to guide the torsion tab through the recess, wherein an extraction after the twisting of the tab head by about 10° up to about 170° around a center longitudinal axis of the torsion tab is inhibited or not possible.

In some configurations the torsion tab is twisted by an angle of about 30° up to about 120°, by about 40° up to about 100°, or by about 45°, among others. In at least one configuration the torsion tab is twisted such that a clamping region cooperates with the sheet metal component. In some configurations the present disclosure provides that the clamping region applies a force onto the sheet metal component during and/or after the torsion or twisting, respectively, of the tab head. In at least one configuration the present disclosure provides that the force corresponds to a spring force which is proportional to a spring constant of the torsion region, especially after the twisting.

In some configurations the present disclosure provides that at least one second torsion tab of the shaped component is guided through a second recess of a second sheet metal component, wherein the second torsion tab is twisted by about 10° to about 170° about its center longitudinal axis, wherein the tab head of the second torsion tab cooperates with the second sheet metal component such that the tab head clamps the second sheet metal component to the main metal sheet of the shaped component. Accordingly, two sheet metal components can be connected to one another in this way using the shaped component. In at least one configuration, two sheet metal components can be joined edge to edge by the shaped component. In some configurations the present disclosure provides that when providing at least two torsion tabs, the torsion tabs extend from the plane of the main metal sheet toward opposing sides of the main metal sheet so that two sheet metal components can be connected parallel to each other, wherein the shaped component is arranged between the sheet metal components. In some configurations the present disclosure provides that by using the shaped component, two sheet metal components can be connected together, in that at least one torsion tab is guided through a recess in a first sheet metal component and simultaneously through a recess in a second sheet metal component and then is twisted around the center longitudinal axis. In this manner, for example, overlapping connections of sheet metal components can be implemented by the shaped component.

In at least one configuration the present disclosure provides that a positioner of the shaped component is inserted into at least one positioning opening of a sheet metal component. Advantageously the positioning opening of the sheet metal component is approximately as large as the dimensions of the positioner.

In some configurations the present disclosure provides that the shaped component is bent along a material attenuation, for example before the connecting of two sheet metal components. In at least one configuration the present disclosure provides that the shaped component is bent along a material attenuation, after the connecting of the two sheet metal components. In some configurations, a sheet metal component is used as a lever in order to bend the shaped component along the material attenuation.

In at least one configuration, the shaped component additionally or alternatively can be connected to the sheet metal components by a screw. In this regard a screw is inserted or screwed through the screw hole and the metal-sheet component and secured in place for example by using a nut. In some configurations, the present disclosure provides that a hex-head screw and/or a nut having an associated screw hole of the shaped component is held in a rotation-locked manner by a non-twisted torsion tab. The screw connection is established through the screw hole in such a manner that one flank of the nut or one flank of the head of the hex-head screw, respectively, essentially rests against, or at least partly rests against, the torsion tab. In at least one configuration the present disclosure provides that a free play is provided between the torsion tab and one flank of the hex-head screw or the nut, that additionally is structured such that the hex-head screw or the nut, respectively, can rotate by no more than about 0.5° up to about 10°, for example no more than by about 1° up to about 5°.

In some configurations, use of a screw connection which is associated with the screw hole, provides for the shaped component to be connected to a sheet metal component which does not have any recess for the torsion tab. Also a screw connection which is associated with the screw hole provides for the shaped component to be connected to a metal-sheet component which does not have any recess for the positioner. For example, a hole is drilled into the sheet metal component which can be aligned with the screw hole of the shaped component. This configuration is advantageous for using the shaped component with sheet metal components which are not adapted to the shaped component, or for example, shortened sheet metal components which do not have any recesses, or do not have suitable recesses for the torsion tabs.

In still yet another form of the present disclosure, a system of a sheet construction is provide and comprises at least one first sheet metal component and at least one shaped component as described above. At least one torsion tab of the shaped component extends at least through at least one first recess of a first sheet metal component, and is twisted by about 10° up to about 170°, by about 30° up to about 120°, by about 40° up to about 100°, or by about 45°, such that a tab head, for example a clamping region of a tab head, of the at least one torsion tab cooperates with the first sheet metal part such that the main metal sheet of the shaped component is clamped to the first sheet metal part.

In some configurations, the present disclosure provides that the system features a second sheet metal component, wherein at least one second torsion tab of the shaped component extends through at least one second recess of the second sheet metal component and is twisted by about 10° to about 170°, by about 30° up to about 120°, by about 40° up to about 100°, or by about 45°, such that a tab head, for example a clamping region of a tab head, of the second torsion tab cooperates with the second sheet metal component such that a main metal sheet of the shaped component is clamped to the second sheet metal component.

In at least one configuration, the present disclosure provides that the recess of the first and/or of the second sheet metal component features a first extension which is greater than an extension of the tab head perpendicular to a center longitudinal axis of the torsion tab and perpendicular to the material thickness of the torsion tab. Furthermore, the recess additionally features a second extension which is greater than a material thickness of the torsion tab and is less than an extension of the tab head perpendicular to a center longitudinal axis of the torsion tab and perpendicular to the direction of the material thickness of the torsion tab, wherein the first extension is essentially perpendicular to the second extension. In this manner the torsion tab can be inserted through the recess and after the torsion of the torsion tab, it is seated in a positive locking manner in the recess around the center longitudinal axis, for example in a positive-locking manner in the direction of the center longitudinal axis.

In some configurations, the present disclosure provides that a material thickness of a sheet metal component is roughly as great as a length of a torsion region in the direction of a center longitudinal axis of the torsion tab. In at least one configuration, the present disclosure provides that a material thickness of a sheet metal component is greater than a length of a torsion region in the direction of a center longitudinal axis of the torsion tab. The torsion region, for example the torsion region in connection with the clamping region of the tab head, is designed such that by twisting of the tab head or by twisting of the torsion tab the clamping region of the tab head will act upon the sheet metal component. In this regard the present disclosure provides that the torsion region is shorter in the direction on the longitudinal axis of the tab head than the material thickness of the sheet metal component. In some configurations the torsion region in the direction of the longitudinal axis of the tab head is at least 20% shorter, at least 50% shorter, or at least 75% shorter than the material thickness of the sheet metal component. In at least one configuration the present disclosure provides that the torsion region has a length in the direction of the center longitudinal axis from up to about one-fourth of the material thickness of the sheet metal component, for example up to about 1.5 times the material thickness of the sheet metal component, up to about one times the material thickness of the sheet metal component, up to about three-quarters of the material thickness of the sheet metal component, or up to about one-half the material thickness of the sheet metal component. The clamping region is configured such that this region is essentially adapted to the opening width of the recess of the sheet metal component. For example, in at least one configuration the present disclosure provides that the torsion region, for example the torsion region in connection with the clamping region, has a length of about 50% up to about 95%, or about 75% up to about 80%, of the material thickness of the sheet metal component, and the clamping region is extended such that in a rotation of about 45° it acts on the sheet metal component such that a force of about 0.1 N up to about 5 N, or about 0.1 N up to about 2 N, is transferred from the clamping region to the sheet metal component.

The clamping of the shaped component with the sheet metal component can provide a reliable electrically conducting connection. Furthermore the clamping of the shaped component with the sheet metal component can provide that the at least one positioner is safely disposed in the at least one positioning opening of the sheet metal component, and any slippage of the positioner from the positioning opening is inhibited or prevented. In this manner a defined positive-locking of the shaped component with the sheet metal component is provided and/or assured. It should be understood that the positive-locking of the shaped component to the sheet metal component is more defined, due to the positioner, than a positive-locking provided solely by the torsion tab.

In some configurations the present disclosure provides that at least one sheet metal component comprises the shaped component. For example, the shaped component is connected to the sheet metal component as a single piece. In at least one configuration the present disclosure provides that the sheet metal component comprises at least one torsion tab. In some configurations the present disclosure provides that the shaped component is a sheet metal component, for example a cable duct.

In some variations of the present disclosure a sheet metal component comprises the shaped component and can be connected to an additional sheet metal component featuring a corresponding recess to accommodate the torsion tab, and no additional component has to be used. For example, the sheet metal components can be positioned next to each other in an overlapping manner, for example in the form of cable ducts, or at least can be positioned partly next to each other.

In some configurations the present disclosure provides that in addition to the shaped component, the system features a connecting part which makes it possible to connect two sheet metal components which each comprising a shaped component. The connecting part comprises at least two recesses for positive-locking accommodation of torsion tabs. In at least one configuration, the connecting part comprises a plate-shaped component that features the at least two recesses. In some configurations the present disclosure provides that the torsion tabs feature at least two shaped components or sheet metal components that feature at least one shaped component, which are guided through recesses of the connecting part and are twisted by about 10° up to about 170°. In this manner the two sheet metal components are connected together by means of the connecting part. In at least one configuration the connecting part advantageously features only the recesses that accommodate the torsion tabs. In some configurations the present disclosure provides that the sheet metal components can be joined edge to edge in this manner.

In at least one configuration the present disclosure provides that the shaped component features at least one positioner that engages in at least one positioning opening of at least one sheet metal component. In this manner a reliable positioning is achieved, for example an exact positioning of the shaped component with respect to the sheet metal component.

In some configurations the present disclosure provides that the positioner extends beyond the main metal sheet, for example beyond a main metal sheet plane of the shaped component, by about 5% up to about 150%, by about 20% up to about 120%, or by about 80% up to about 100% of the material thickness of the sheet metal component.

In one form of the present disclosure, a system of a sheet metal construction comprises a first sheet metal component and a second sheet metal component and also the shaped component. The shaped component is arranged against the first and/or second sheet metal component in such a manner that two or four torsion tabs each extend through a recess. At least one first torsion tab extends, for example, through the first recess of the first sheet metal component, and at least one second torsion tab extends, for example through the second recess of the second sheet metal component. The sheet metal components are joined together edge to edge. The torsion tabs are twisted about the particular longitudinal axis to obtain a positive-locking and frictional connection of the shaped component to the sheet metal components. The clamping regions of the torsion tabs act on the sheet metal components.

In some configurations, the present disclosure provides that at least one sheet metal component is a cable guide component, selected from a group comprising a cable guide, a cable channel, a cable trough and/or a cable trough covering.

In at least one configuration the shaped component is designed in such that it can connect two cable guide components together. In some configurations the present disclosure provides that the sheet metal components designed as a cable guide component have a U-shape, for example a trough-shaped configuration. The legs of the cable guide component feature recesses to accommodate torsion tabs of the shaped component. In at least one configuration a base of the cable guide component features recesses to accommodate torsion tabs of the shaped component. In some configurations the present disclosure provides that at least one wall, for example at least one leg and/or the base of the cable guide component features at least one torsion tab. In at least one configuration the present disclosure provides that the legs, or alternatively or additionally the base of the cable guide component, feature(s) at least one, for example at least two recesses for the accommodation of at least one torsion tab, for example at least two torsion tabs. In at least one configuration the present disclosure provides that a shaped component, designed as a cable guide component, features on one side at least one torsion tab, and on the opposing side at least one recess for a torsion tab. In this manner it is provided that cable guide components can be combined together and connected such that as equally structured cable ducts with at least one connecting tab on the one side and a recess on the other side can be mounted in series one after the other. In some configurations the present disclosure provides that, for example, a shaped component, configured as a covering for a cable guide component, features at least one, for example at least two recesses for the accommodation of at least one torsion tab, for example at least two torsion tabs.

In at least one configuration the present disclosure provides that a cable duct comprises at least two cable guide components and there are recesses and positioning openings disposed in the ends of the cable guide components. The recesses are designed to accommodate the torsion tabs and the positioning openings are configured to accommodate the positioners. In some configurations the cable guide components are connected together edge to edge. In at least one configuration at least two shaped components each engage with their torsion tabs into the recesses of the cable guide components such that they are connected together at least in a positive-locking, for example in a friction-locked manner. In some configurations the present disclosure provides that at least one cable guide component is designed as a corner component. In such configurations a cable duct is twisted by about 45° up to about 90° using the corner component. In at least one configuration the present disclosure provides that a first shaped component is configured as being bent by about 45° up to about 90°, for example along the material attenuation in order to connect together the walls of the cable guide components standing at an angle of about 45° to 90° to each other. In some configurations the present disclosure provides that a second shaped component is configured as not bent and in particular connects together straight standing walls of the cable guide components. The torsion tabs of the shaped component which are connected to the cable guide components are twisted in order to affect a positive-locking, for example a friction-locking connection of the shaped components to the cable duct components. In at least one configuration at least two, for example four positioners are provided such that a defined friction lock of the shaped component to the cable duct components is provided or assured.

In some configurations the shaped component is configured as a connecting element or connector for connecting two sheet metal components together. The shaped component is an essentially sheet-like component. In at least one configuration the shaped component is an essentially sheet-like component in which only the torsion tabs and/or the positioners extend beyond the main metal sheet plane.

Furthermore, a use of the shaped component as described above for connecting to at least one sheet metal component is provided. In one form the shaped component is used for connecting of at least two sheet metal components. For example, the shaped component is used for connecting of at least two cable guide components.

Additional advantageous configurations are indicated in the following figures. However, the refinements depicted there are not to be interpreted as restrictive, rather the features described therein can be combined with each other and with the features described above to obtain additional configurations. Furthermore, it should be pointed out that the reference symbols indicated in the description of figures do not restrict the scope of protection, but rather merely refer to the exemplary examples shown in the figures. The same parts or parts having the same function will have the same reference symbols hereinafter.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a shaped component in isometric view;

FIG. 2 is the shaped component from FIG. 1 in a top view;

FIG. 3 is the shaped component from FIG. 2 in cross section III-III;

FIG. 4 is the shaped component from FIG. 2 in cross sectional view IV-IV;

FIG. 5 is a detailed view V from FIG. 4;

FIG. 6 is a system comprising the shaped component and also two sheet metal components;

FIG. 7 is a detailed view VII from FIG. 1;

FIG. 8 is a top view of the shaped component in which the torsion tabs and the positioning means are located in the main metal sheet plane;

FIG. 9 is an alternative form of a shaped component;

FIG. 10 is a cable duct;

FIG. 11 is a shaped component used as a tool; and

FIG. 12 is a detailed view from FIG. 11.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

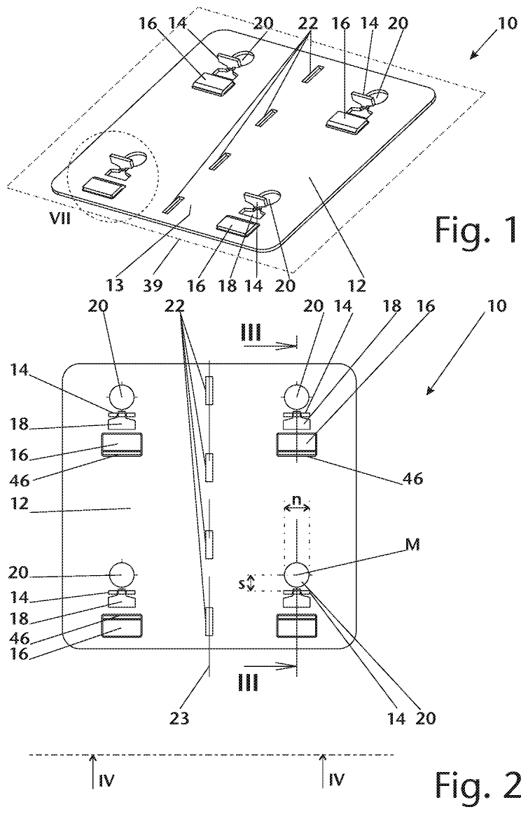

FIG. 1 shows a shaped component 10 in an isometric view. The shaped component 10 is designed as a connecting element, also designated as a connector. The shaped component 10 features a main metal sheet 12 and the main metal sheet 12 comprises a surface 13 that is arranged in a main metal sheet plane 39. There are four torsion tabs 14 extending from the main metal sheet 12 in the depicted form shown in FIG. 1. Positioners 16 and screw holes 20 are each associated with the torsion tabs 14. The torsion tabs 14 extend essentially perpendicular to the main metal sheet plane 39 from the surface 13 of the main metal sheet 12. In some variations of the present disclosure, each of the torsion tabs 14 extend in the same direction from the surface 13 of the main metal sheet 12. The positioners 16 are likewise elevated and/or extend from the main metal sheet plane 39. Both the torsion tabs 14 and the positioners 16 are detached from, for example punched out from the material of the main metal sheet 12. By bending the torsion tabs 14 out from the main metal sheet plane 39, openings 18 are produced which are allocated to the torsion tabs 14. Furthermore, FIG. 1 indicates that the main metal sheet 12 features a number of rectangular material attenuations 22 which are arranged in or along a straight line. The material attenuations 22 each separate two mirror-symmetrical pairs of torsion tabs 14 with associated positioners 16 and screw holes 20 along a deformation line 23 (see FIG. 2) formed by the material attenuations 22. In some variations the material attenuations 22 are structured such that a slight bending along the deformation line 23 which is evident in FIG. 2, and is created by the material attenuations 22, is easily possible by using a hand tool (not illustrated) or by hand.

FIG. 2 depicts a top view of the shaped component 10 from FIG. 1. In this view it is evident that the main metal sheet 12 features four torsion tabs 14 and each torsion tab 14 is associated with a screw hole 20 and one positioner 16 and one opening 18.

The torsion tabs 14 are arranged upon the main metal sheet 12 such that every two torsion tabs are arranged mirror-symmetrical to each other, wherein in particular the deformation line 23 formed by the material attenuation 22 forms the axis of symmetry. For example, from FIG. 2 it is evident that the openings 18 from which the torsion tabs 14 are bent out, are each arranged as pointing in the same direction relative to the torsion tabs 14. Furthermore, the positioners 16 are each allocated to the openings 18. Also the configuration of the positioners 16 is such that every two positioners 16 are arranged along an axis of symmetry reflected on the main metal sheet 12. In particular, the positioners 16 feature tilting areas 46 directed toward each other on one side of the deformation line 23. The tilting areas 46 are the sections of the positioners 16 which are bent around such that the positioners 16 extend from the main metal sheet plane 39 out over the main metal sheet 12, as depicted in FIG. 1. Simultaneously the tilting area 46 is of the section of the positioners 16 which is connected to the main metal sheet material.

In some variations of the present disclosure, a torsion tab 14 can be configured as a twist guard for a nut or hex-head screw (not illustrated). In this regard the screw hole 20 is allocated to the torsion tab 14 and a distance ‘s’ from a midpoint ‘M’ of the screw hole 20 to the torsion tab 14 corresponds to one half the wrench width which is allocated to a nominal diameter ‘n’ of the screw hole 20 according to DIN EN 24014 Standard in connection with DIN EN 24017 Standard dated February 1992.

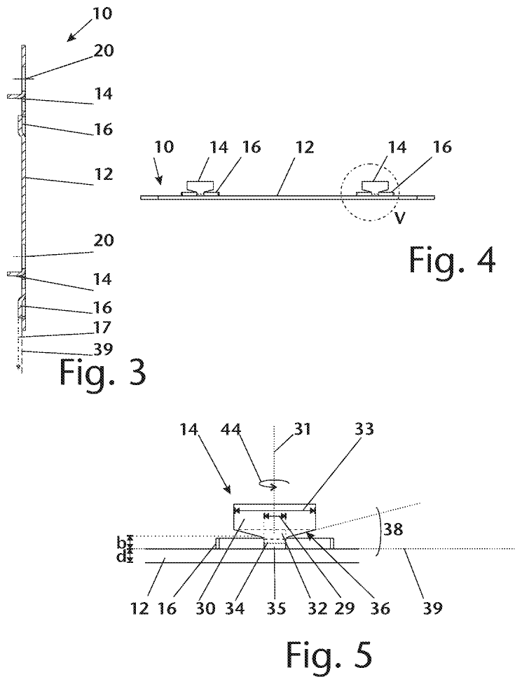

FIG. 3 depicts a cross sectional view III-III of the shaped component 10 from FIG. 2. FIG. 3 indicates that the torsion tabs 14 are materially connected to the main metal sheet 12, that is, the main metal sheet 12 and the torsion tabs 14 are designed and formed as a single piece. The positioners 16 are also materially connected to the main metal sheet 12, that is, designed and formed as a single piece, by double bending. The screw holes 20 are through openings that are not threaded in the illustrated form. It is also evident in FIG. 3 that the positioners 16 features an area extension 17 that is parallel to the main metal sheet plane 39.

FIG. 4 presents a view IV-IV from FIG. 2. This view shows the shaped component 10 with the main metal sheet 12 from which the torsion tabs 14 and the positioners 16 extend from the main metal sheet plane 39 defined by the surface of the main metal sheet 12.

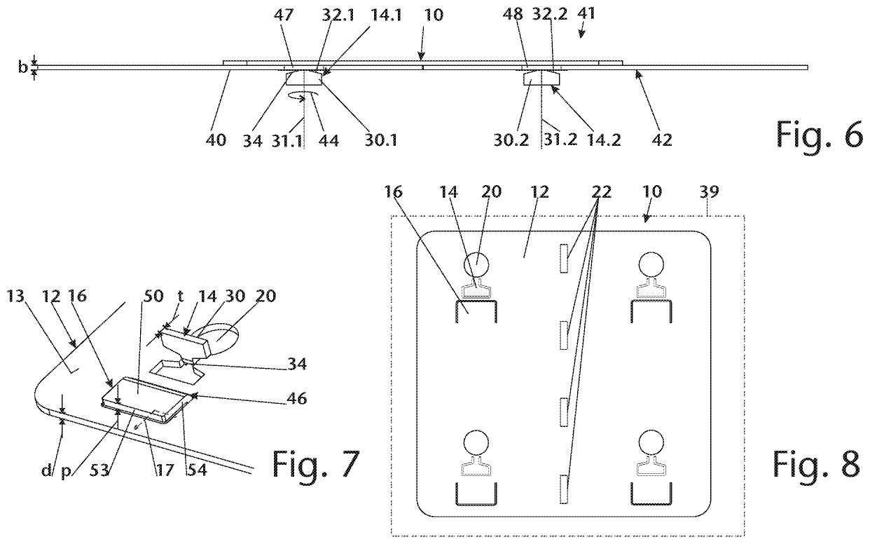

FIG. 5 provides a detailed view V from FIG. 4. The main metal sheet 12, the positioners 16, and the torsion tab 14 are indicated in this view. The torsion tab 14 has a torsion region 34 and a tab head 30. The tab head 30 features an extension 33 which is significantly broader than an extension 29 of the torsion region 34. The tab head 30 features a clamping region 32 which broadens, for example consistently or continuously, proceeding from the torsion region 34 in the direction of the center longitudinal axis 31 and away from the torsion region 34. In the depicted form, cheeks 36 of the clamping region 32 are designed as being arranged straight in a longitudinal section in a top view. The cheeks 36 feature an angle 38 to the main metal sheet plane 39 which ranges, in some variations of the present disclosure, from about 12° up to about 28°. The torsion region 34 comprises a foot region 35 which is an angled and/or a bent section, and the foot region 35 is, in some variations, materially connected or is connected as a single piece to the main metal sheet 12. It should be understood that the torsion region 34 is that section of the torsion tab 14 which is primarily deformed by the twisting or torsion 44 of the torsion tab 14 about the center longitudinal axis 31. Depending on a torsion 44 on the torsion tab 14, a deformation can also occur in the tab head 30, for example in the clamping region 32 and/or in the region of the clamping region 32 adjoining the torsion region 34. Furthermore, the clamping region 32 is designed or configured such that after the torsion 44 of the torsion tab 14, the clamping region 32 features a distance (not illustrated), at least in one partial region, which corresponds to an expected sheet thickness ‘b’ of a sheet metal component 40, 42 which is connectable to the shaped component 10 and is shown in FIG. 6. In some variations, the sheet metal component 40 is plate-shaped, but can also feature any other shape; for example, it can be designed as a cable guide component. Due to the illustrated form, for example due to the cheek 36 of the clamping region 32 arranged at an angle to the main metal sheet plane 39, different sheet metal components 40, 42 with different sheet thicknesses b can be connected to the shaped component 10. The direction of the torsion 44 shown in the figures is arbitrary and can also occur in the opposite direction.

FIG. 6 shows a system of a sheet construction 41 comprising a first sheet metal component 40 and a second sheet metal component 42 and also the shaped component 10. The shaped component 10 is disposed up against the sheet metal components 40 and 42 such that the torsion tabs 14.1 and 14.2 extend through a first recess 47 and a second recess 48. The first torsion tab 14.1 extends here through the first recess 47 of the first sheet metal component 40, and the second torsion tab 14.2 extends through the second recess 48 of the second sheet metal component 42. The sheet metal components 40 and 42 are joined together edge to edge. The torsion tabs 14.1 and 14.2 are twisted in the direction of the arrow or opposite the direction of the arrow 44, around the particular longitudinal axis 31.1 and 31.2 to obtain a positive-locking and frictional connection of the shaped component to the sheet metal components 40 and 42. The clamping regions of the torsion tabs 14.1 and 14.2 and the clamping regions 32.1 and 32.2 act here on the sheet metal components 40 and 42.

FIG. 7 provides a detailed view VII from FIG. 1. From this illustration it is evident that the positioner 16 features a surface 50 which extends in the direction of the area extension 17, which is likewise shown in FIG. 3, and the surface 50 of the positioner 16 is parallel to a surface 13 of the main metal sheet 12. An edge 53 generates a definable boundary of the positioner 16 as does the tilting areas 46 such that a defined positioning of the sheet metal component 40 or 42 is provided. Furthermore, in FIG. 7 it is evident that the main metal sheet 12 features a material thickness ‘d’ which is essentially identical to the material thickness ‘p’ of the positioner 16. Furthermore, the torsion tab 14 features a material thickness ‘t’ which is essentially identical to the material thickness d of the main metal sheet 12. The material thickness d of the tab head 30 and of the torsion region 34 is essentially the same.

FIG. 8 shows the shaped component 10 in a variant in which the torsion tabs 14 and also the positioners 16 are located in the main metal sheet plane 39, wherein in an additional form, the positioner 16 can also protrude from the main metal sheet plane 39. In particular, the torsion tabs 14, the positioner 16, and also the screw holes 20 and the material attenuation 22 are punched out from the main metal sheet 12 for example in one work step. A bending and/or edging of the torsion tabs 14 and of the positioners 16 does not occur. This reduces in particular the warehousing costs and shipping costs, since a shaped component punched out in this manner requires significantly less storage space. The positioners 16 and/or the torsion tabs 14 can each be bent out and mounted as needed at the installation site.

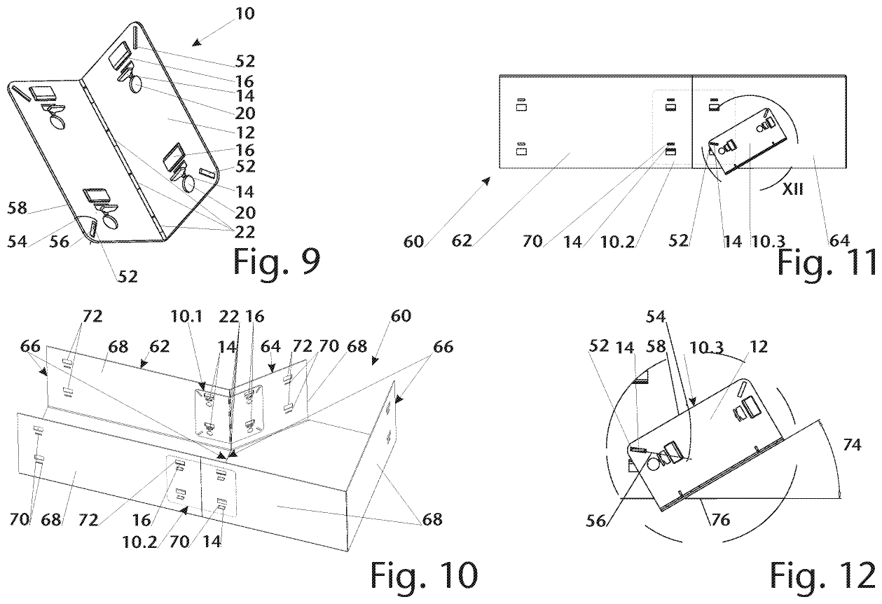

FIG. 9 depicts an alternative design of the shaped component 10 which features tool openings 52 in addition to the torsion tabs 14, the positioners 16, and the screw holes 20. In the illustrated design the tool openings 52 are disposed in all four corners of the main metal sheet 12. The tool openings 52 are of rectangular and elongated configuration, in particular such that a torsion tab 14 of an additional shaped component 10 can be inserted through the tool opening 52. In some variations, a longitudinal extension 56 of the tool opening 52 is disposed at an angle 54 of about 45° to an outer edge 58 of the main metal sheet 12.

FIG. 10 depicts a cable duct 60 comprising two cable duct components 62 and 64. The cable duct components 62 and 64 feature recesses 70 and positioning openings 72 disposed at the ends 66 of their walls 68. These recesses 70 are configured to accommodate the torsion tabs 14. The positioning openings 72 are configured to accommodate the positioners 16. The two cable duct components 62 and 64 are joined together edge to edge. The torsion tabs 14 of the shaped components 10.1 and 10.2 each engage in the recesses 70 of the cable duct components 62 and 64 so that they are connected together. The cable duct component 64 is designed as a corner component with which the cable duct 60 can be twisted by about 90°. The shaped component 10.1 has a bent configuration by about 45° along the material attenuation 22 in order to connect together the walls 68 of the cable duct components 62 and 64 standing at an angle of about 45° to each other. The shaped component 10.2 is indicated by dashed lines and is not bent and connects the mutually aligned walls 68 of the cable duct components 62 and 64. From FIG. 10 the assembled state shows how the torsion tabs 14 are not yet twisted to effect a friction-locked and positive-locking connection of the shaped components with the cable duct components 62 and 64.

FIG. 11 shows the cable duct 60 from FIG. 10 with the cable duct components 62 and 64 in a front view. The shaped component 10.2 indicated by dashed lines connects the two cable duct components 62 and 64, wherein the torsion tabs 14, which engage through the recesses 70, are not yet twisted. An additional shaped component 10.3 is bent off by about 90° around the material attenuation (not illustrated in FIG. 11). The tool opening 52 of the shaped component 10.3 engages in a torsion tab 14 of the shaped component 10.2.

FIG. 12 shows a detailed view XII of FIG. 11. It is evident that the tool opening 52 is arranged on the shaped component such that a rotation of the shaped component 10.3 about an angle 74 of about 45° causes a sufficient torsion of the torsion tab 14 in order to clamp the shaped component 10.2 to the cable duct component 64. As already indicated in FIG. 9, a longitudinal extension 56 of the tool opening 52 is disposed at an angle 54 of about 45° to an outer edge 58 of the main metal sheet 12. In particular the tool opening 52 is installed in the main metal sheet 12 such that a rotation of the shaped component 10.3 into a horizontal position, that is, a position in which the outer edge 58 of the shaped component 10.3 is essentially parallel to a component edge 76 of the cable duct 60, causes a sufficient torsion of the torsion tab 14 to clamp the shaped component 10.2 to the cable duct component 64.

With the described shaped component comprising a main metal sheet and at least one torsion tab, with the method for connecting of at least one first sheet metal component to one such shaped component and with the system of a sheet construction comprising at least a first sheet metal component and at least one shaped component, in an advantageous manner any particular favorable connection of sheet metal components can be implemented, in particular of cable guide components such as cable ducts. In particular, no time-consuming and costly assembly steps are needed to connect sheet metal components to each other.

Unless otherwise expressly indicated herein, all numerical values indicating mechanical/thermal properties, compositional percentages, dimensions and/or tolerances, or other characteristics are to be understood as modified by the word “about”, “essentially” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A shaped component for connecting two components, the shaped component comprising:
a main metal sheet with at least two torsion tabs, wherein each of the at least two torsion tabs comprise a torsion region and a tab head, wherein an extension of the torsion region perpendicular to a center longitudinal axis of the torsion tab is smaller than an extension of the tab head perpendicular to the center longitudinal axis of the torsion tab, and wherein the tab head comprises a clamping region and wherein the torsion tabs extend from the main metal sheet and protrude from a main metal sheet plane.

2. The shaped component according to claim 1, wherein the at least two torsion tabs are connected to the main metal sheet as a single piece.

3. The shaped component according to claim 1, wherein the main metal sheet further comprises at least two screw holes and a distance of a midpoint of each of the at least two screw holes to a corresponding torsion tab is equal to about one-half of a hex-head wrench width, wherein the hex-head wrench width correlates with a nominal diameter of each of the at least two screw holes.

4. The shaped component according to claim 1 further comprising at least one positioner extending from the main metal sheet.

5. The shaped component according to claim 1 further comprising at least one material attenuation between the at least two torsion tabs.

6. The shaped component according to claim 1, wherein the shaped component is configured as at least one of a cable guide, a cable channel, a cable trough and a cable trough covering.

7. The shaped component according to claim 1, wherein the main metal sheet comprises at least one tool opening for twisting of one torsion tab of a second shaped component.

8. The shaped component according to claim 1, wherein the at least two torsion tabs are connected to the main metal sheet as a single piece and the main metal sheet further comprises at least two screw holes with a distance of a midpoint of each of the at least two screw holes to a corresponding torsion tab equal to about one-half of a hex-head wrench width, wherein the hex-head wrench width correlates with a nominal diameter of each of the at least two screw holes.

9. The shaped component according to claim 8 further comprising at least one positioner extending from the main metal sheet.

10. The shaped component according to claim 9 further comprising at least one material attenuation between the at least two torsion tabs.

11. A method for connecting of at least two cable guide components, the method comprising:
guiding a first torsion tab of a shaped component through a first recess of a first cable guide, wherein the shaped component comprises a main metal sheet with the first torsion tab and a second torsion tab;
twisting the first torsion tab by about 10° to about 170° about a center longitudinal axis of the first torsion tab, wherein a first tab head of the first torsion tab cooperates with the first cable guide component such that the first tab head tensions the first cable guide with the main metal sheet of the shaped component;
guiding a second torsion tab of the shaped component through a second recess of a second cable guide; and
twisting the second torsion tab by about 10° to about 170° about a center longitudinal axis of the second torsion tab, wherein a second tab head of the second torsion tab cooperates with the second cable guide component such that the second tab head tensions the second cable guide with the main metal sheet of the shaped component.

12. The method according to claim 11, wherein the shaped component is bent along a material attenuation before connecting the first cable guide component to the second cable guide component.

13. The method according to claim 11, wherein a hex-head screw or a nut associated with a screw hole of the shaped component is held in a twist-preventing manner by one of the first and second torsion tabs before it is twisted.

14. The method according to claim 11, wherein the first and second torsion tabs are connected to the main metal sheet as a single piece and the main metal sheet further comprises at least two screw holes with a distance of a midpoint of each of the at least two screw holes to a corresponding torsion tab equal to about one-half of a hex-head wrench width, wherein the hex-head wrench width correlates with a nominal diameter of each of the at least two screw holes.

15. The method according to claim 14, wherein the first cable guide is positioned relative to the shaped component with a first positioner and the second cable guide is positioned relative to the shaped component with a second positioner.

16. The method according to claim 15, wherein the first cable guide and the second cable guide connected to each other end-to-end.

17. A system of a sheet metal structure comprising:
a first cable guide component, a second cable guide component and at least one shaped component configured as a connecting element between the first cable guide component and the second cable guide component, the at least one shaped component comprising a main metal sheet, at least one first torsion tab extending from the main metal sheet and through at least one first recess of the first cable guide component, and at least one second torsion tab extending from the main metal sheet and through at least one second recess of the second cable guide component, wherein the at least one first torsion tab is twisted by about 10° to about 170° about a first torsion tab center longitudinal axis such that a tab head of the at least one first torsion tab engages the first cable guide component and the main metal sheet of the shaped component is tensioned with the first cable guide component, and the at least one second torsion tab is twisted by about 10° to about 170° about a second torsion tab center longitudinal axis such that a tab head of the at least one second torsion tab engages he second cable guide component and the main metal sheet of the shaped component is tensioned with the second cable guide component.

18. The system according to claim 17, wherein the first cable guide is positioned relative to the shaped component with a first positioner and the second cable guide is positioned relative to the shaped component with a second positioner.

19. The system according to claim 18, wherein the first positioner and the second positioner extend from the main metal sheet.

20. The system according to claim 17, wherein the at least one shaped component further comprises a material attenuation and the at least one shaped component is bent along the material attenuation.
